(19) United States
(12) Patent Application Publication
(10) Pub. No.: US 2015/0004890 A1
(43) Pub. Date: Jan. 1, 2015

(54) NICKEL COATED DIAMOND PARTICLES AND METHOD OF MAKING SAID PARTICLES

(71) Applicant: Saint-Gobain Ceramics & Plastics, Inc., Worcester, MA (US)

(72) Inventors: Zoran KRSTIC, Dunmore, PA (US); William MECCA, South Abington Township, PA (US); Andrew G. HAERLE, Sutton, MA (US); Nicholas J. TUMAVITCH, South Abington Township, PA (US); Brian C. SHAFFER, Archbald, PA (US)

(21) Appl. No.: 14/316,001

(22) Filed: Jun. 26, 2014

Related U.S. Application Data
(60) Provisional application No. 61/840,699, filed on Jun. 28, 2013.

(51) Int. Cl. C09K 3/14; B24D 11/00

(52) U.S. Cl. CPC C09K 3/1445; B24D 11/00
USPC 451/533; 51/309

(57) ABSTRACT

A method of evenly coating small abrasive particles, specifically a method of coating diamond particles≦10 μm with nickel, and an abrasive article containing the coated abrasive particles, for example, a fixed diamond wire. The method includes applying ultrasonic energy to the plating bath and adjusting the power of the ultrasonic energy that a non-agglomeration factor (NAF) of the batch of abrasive particle is at least about 0.9, the non-agglomeration factor defined as a ratio (D50ₛₐ/D50_{b}), wherein D50_{b} represents the median particle size of the coated abrasive particles and D50ₛₐ represents the median particle size of the abrasive particles prior to coating.

### CROSS-REFERENCE TO RELATED APPLICATION

This application claims priority under 35 U.S.C. §119(e) to U.S. Patent Application No. 61/840,699 entitled “NICKEL COATED DIAMOND PARTICLES AND METHOD OF MAKING SAID PARTICLES,” by Zoran Krstic et al., filed Jun. 28, 2013, which is assigned to the current assignee hereof and incorporated herein by reference in its entirety.

### FIELD OF THE DISCLOSURE

The present disclosure relates to a method of coating small abrasive particles, specifically to a method of making nickel-coated diamond particles. The disclosure also relates to an abrasive article, such as a fixed diamond wire including the nickel-coated diamond particles.

### BACKGROUND

Slicing of silicon wafers for solar devices or sapphire wafers for LED applications requires fixed diamond wire (FDW) having small micron-sized diamond particles attached to the wire through resin or electroplated bonding. To minimize kerf loss during sawing on silicon and sapphire wafers and to provide extremely high wafer quality without or minimal surface damage and minimal need for additional downstream processing, there is a continuous demand of thinner FDW with smaller sizes of the diamond particles. For example, from the mid-1990s until today, the wire diameter dropped from 180 μm to typically 120 μm, with some production excursions at R&D level even down to 100 μm and 80 μm.

A known process to fix small diamond particles unto a wire substrate is coating the diamond particles with nickel by electroless plating, and further attaching the nickel-coated diamond particles via nickel electroplating to the wire net. In view of the ever-decreasing size of the diamond particles, it becomes difficult to apply an even and continuous nickel coating to the diamond particles. Accordingly, as particle sizes of diamond become increasingly smaller, handling, manufacturing, and production of such fine abrasive materials has increasing challenges. The industry continues to demand finer abrasive materials for use in a variety of applications.

### SUMMARY

According to one aspect, a method for forming a batch of coated abrasive particles includes providing a dispersion of abrasive particles in a bath, wherein an average particle size of the abrasive particles is ≦10 μm; coating the abrasive particles in the bath with a coating material; applying ultrasonic energy to the bath and adjusting a power of the ultrasonic energy to form a batch of coated abrasive particles having a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating. In a preferred aspect, the method relates to forming a batch of nickel-coated diamond particles.

According to another aspect, a method for making an abrasive article includes providing a substrate and attaching a batch of coated abrasive particles to the substrate, wherein the batch of abrasive particles comprises a non-agglomeration factor (NAF) of at least about 0.9, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating. In a particular embodiment, the method can relate to making a fixed diamond wire (FDW).

In yet another aspect, a batch of coated abrasive particles can have an average particle size≦10 μm and a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating. Preferably, the batch of abrasive particles contains nickel-coated diamond particles.

### BRIEF DESCRIPTION OF THE DRAWINGS

The present disclosure may be better understood, and its numerous features and advantages made apparent to those skilled in the art by referencing the accompanying drawings.

FIG. 1 shows a series of four SEM images with different stages of agglomeration of nickel coated diamond particles until an agglomeration-free stage is reached. Only the last image of the image series falls under the presently claimed invention.

FIG. 2A is an SEM image of a particle sample of Experiment E1; FIG. 2B is a graph of the particle size analysis of the sample of Experiment E1. The sample of Experiment 1 is representative of the present invention.

FIG. 3A is an SEM image of a particle sample of Experiment E2; FIG. 3B is a graph of the particle size analysis of the sample of Experiment E4. The sample of Experiment E2 is representative of the present invention.

FIG. 4A is an SEM image of a particle sample of Experiment E3; FIG. 4B is a graph of the particle size analysis of the sample of Experiment E5. The sample of Experiment E3 is representative of the present invention.

FIG. 5A is an SEM image of a particle sample of Experiment E4; FIG. 5B is a graph of the particle size analysis of the sample of Experiment E6. The sample of Experiment E4 is representative of the present invention.

FIG. 6A is an SEM image of a particle sample of Experiment E5; FIG. 6B is a graph of the particle size analysis of the sample of Experiment E7. The sample of Experiment E5 is representative of the present invention.

FIG. 7A is an SEM image of a particle sample of Experiment E6; FIG. 7B is a graph of the particle size analysis of the sample of Experiment E8. The sample of Experiment E6 is representative of the present invention.

FIG. 8A is an SEM image of a particle sample of Comparative Experiment C1; FIG. 8B is a graph of the particle size analysis of the sample of Comparative Experiment C1.

FIG. 9A is an SEM image of a particle sample of Comparative Experiment C2; FIG. 9B is a graph of the particle size analysis of the sample of Comparative Experiment C2.

FIG. 10A is an SEM image of a particle sample of Comparative Experiment C3; FIG. 10B is a graph of the particle size analysis of the sample of Comparative Experiment C3.

FIG. 11A is an SEM image of a particle sample of Comparative Experiment C4; FIG. 11B is a graph of the particle size analysis of the sample of Comparative Experiment C4.

FIG. 12A is an SEM image of a particle sample of Comparative Experiment C5; FIG. 12B is a graph of the particle size analysis of the sample of Comparative Experiment C5.

FIG. 13A is an SEM image of a particle sample of Comparative Experiment C6; FIG. 13B is a graph of the particle size analysis of the sample of Comparative Experiment C6.

FIG. 14 is a graph of the particle size analysis of uncoated small diamond particles, which is the reference sample in the experiments of the present specification.

FIG. 15A is an SEM image of a nickel-coated diamond particle coated with an even 20 wt % nickel coating according to Example E6 of the present invention, having a NAF of 0.985;

FIG. 15B is an SEM image of a nickel-coated diamond particle which has been coated in a batch of agglomerated diamond particles according to Comparative Example C5, having a NAF of 0.471.

FIG. 16A is an SEM image of a particle sample of Comparative Experiment C7 before crushing and sieving; FIG. 16B is an SEM image of a particle sample of Comparative Experiment C7 after crushing and sieving.

FIGS. 17A and 17B are SEM images of an embodiment showing nickel-coated diamond particles with average particle size below 10 μm and 20 wt % nickel coating and a NAF larger than 0.9 before sieving (17A) and after sieving (17B) through a 10 micron-size sieve.

FIG. 18 includes a cross-sectional illustration of a portion of an abrasive article in accordance with an embodiment.

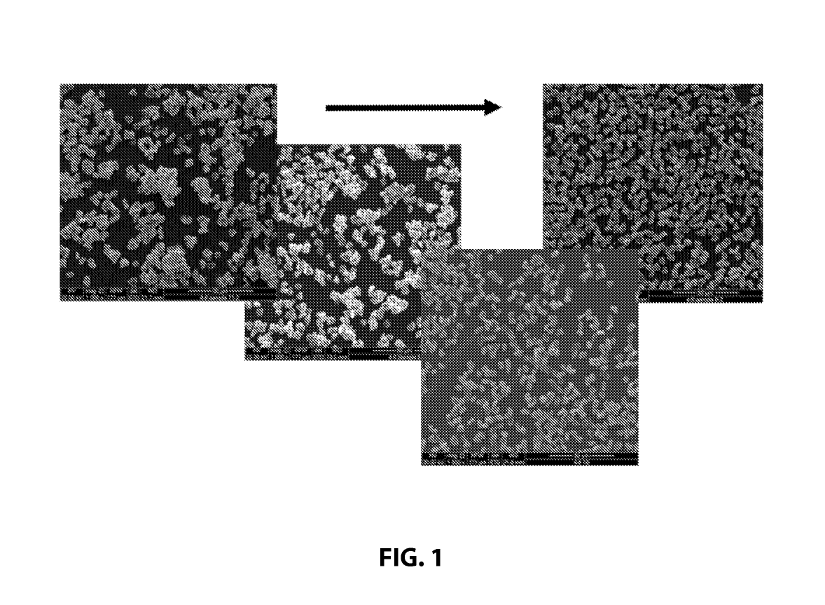

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Various embodiments of the present disclosure will now be described, by way of example only, with reference to the accompanying drawings.

As used herein, the “average particle size” relates to the volume mean particle size.

As used herein, “D50” relates to the median diameter of a particle size distribution, which means that 50% of the particles are above and 50% are below the size of the D50 value.

The present specification is directed to a batch of coated abrasive particles and a method of forming the batch of coated abrasive particles. The method includes providing a dispersion of abrasive particles with an average particle size≦10 μm in a bath; coating the abrasive particles in the bath with a coating material; applying ultrasonic energy to the bath and adjusting the power of the ultrasonic energy to form a batch of coated abrasive particles having a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

The material of the abrasive particles may be any of the following, but not limited to this list: superabrasives, such as diamond or cubic boron nitride; and abrasives, such as silicon carbide, boron carbide, alumina, silicon nitride, tungsten carbide, zirconia, or any combination thereof. In at least one embodiment, the abrasive particles consist essentially of diamond.

In particular instances, the abrasive particles can have a Mohs hardness of at least about 7, such as at least about 8, at least about 8.5, at least about 9, or even at least about 9.5. In at least one embodiment, the Mohs hardness can be within a range from about 7 to about 10, or even from a range from about 9 to 10.

The coating material of the coated abrasive particles may be a metal or metal alloy, including for example, a transition metal. Some suitable metals can include nickel, zinc, titanium, copper, chrome, bronze, or combinations thereof. In a particular aspect, the coating material can be a nickel-based alloy, such that the coating may contain a majority content of nickel, such as at least 60 wt % nickel based on the total weight of the coating. In another embodiment, the coating may consist essentially of nickel.

In certain instances, the bath, and likewise the coating, may contain activators. Suitable activators can include metals, such as silver (Ag), palladium (Pd), tin (Sn), zinc (Zn), and a combination thereof. Generally, such activators may be present in minor amounts such as less than about 1 wt % based on the total weight of solids in the bath. In other instances, the amount of activators can be less, such as less than about 0.8 wt %, less than about 0.5 wt %, less than about 0.2 wt %, or less than about 0.1 wt %.

Additionally, the bath and in some instances the coating, may contain a minor content of certain impurities, including metal elements such as iron (Fe), cobalt (Co), aluminum (Al), calcium (Ca), boron (B), chromium (Cr), and a combination thereof. One or more of the impurities may be present in a minor amount, particularly less than about 50 ppm, less than about 20 ppm, or less than about 10 ppm.

The content of abrasive particles in the dispersion of the plating bath can be at least about 1 wt %, such as at least about 1.5 wt %, or at least about 2 wt % based on the total weight of the plating bath. In another aspect, the content of abrasive particles in the plating bath may be not larger than about 10 wt %, such as not larger than about 8 wt %, or not larger than about 5 wt %. It will be appreciated that the content of abrasive particles in the plating bath may be in a range from any of the minimum to maximum values noted above, such as from about 1 wt % to about 10 wt %, from about 1.5 wt % to about 5 wt %, or from about 1.7 wt % and 3.0 wt %.

In an embodiment, the average particles size of the coated abrasive particles in a batch may be at least about 1 μm, such as at least about 2 μm, at least about 3 μm or at least about 4 μm. Furthermore, the average particle size of the coated abrasive particles may be not greater than about 10 μm, such as not greater than about 9 μm, not greater than about 8 μm, not greater than about 7 μm or not greater than about 6 μm. It will be appreciated that the average particle size can be in a range from any of the minimum to maximum values noted above, such as from about 1 μm to about 10 μm, from about 2 μm to about 8 μm, or from about 4 μm to about 6 μm.

The batch of coated abrasive particles of the present specification can contain abrasive particles wherein at least 95% of the particles comprise a conformal coating which extends over the entire surface area of the abrasive particles. In particular instances, at least 96%, at least 97%, at least 98%, at least 99%, at least 99.5% or at least 99.9% of the abrasive particles can contain a conformal coating extending over the entire surface area of the particles.

According to embodiments herein, the non-agglomeration factor (NAF) can be a relationship between the median particle size of the abrasive particles before and after conducting the coating process. In particular, the non-agglomeration factor may be described by the formula

NAF=D50ₛₐ/D50_{b} (formula 1)

wherein D50ₛₐ represents the median particle size before coating the abrasive particles and D50_{b} represents the median particle size after completing the coating process. It has been found that a NAF of at least about 0.9 or greater corresponds to a batch of abrasive particles having very minor or no agglomeration.

In one embodiment, after completing the coating process, the batch of coated abrasive particles can have a NAF of at least about 0.9. In another embodiment, the NAF can be at least about 0.92, such as at least about 0.94, at least about 0.96, at least about 0.97, at least about 0.98, or even at least about 0.99.

According to one embodiment, the coating process may use a particular power for the ultrasonic energy delivered to the bath during the coating process to facilitate formation of the batch of coated abrasive particles having the features of the embodiments herein. The power of the ultrasonic can be adjusted that a NAF of at least 0.9 is reached. For example, the power of the ultrasonic energy may be at least about 50 Watt, such as at least about 70 Watt, at least about 100 Watt, at least about 150 Watt, at least about 200 Watt, at least about 400 Watt, at least about 600 Watt, or at least about 800 Watt. Furthermore, adjusting of the power may include using a power not greater than about 1000 Watt, such as not greater than about 900 Watt, not greater than about 800 Watt, not greater than about 600 Watt, not greater than about 450 Watt, or not greater than about 200 Watt. It will be appreciated that the power can be in a range from any of the above minimum to maximum values or even higher or lower.

The average thickness of the coating of the abrasive particles when having a NAF of at least about 0.9 can be at least about 1 nm, such as at about least 5 nm, at least about 10 nm, at least about 15 nm, at least about 50 nm or at least about 100 nm. In another embodiment, the average thickness of the coating layer may be not greater than about 500 nm, such as not greater than about 400 nm, not greater than about 300 m, or not greater than about 150 nm. It will be appreciated that the average thickness of the coating of the abrasive particles may be in a range from any of the minimum to maximum values noted above, such as from about 1 nm to about 500 nm, from about 30 nm to about 400 nm, from about 50 nm to about 200 nm, or from about 60 nm to about 130 nm

In another embodiment, the total weight of the coating of the abrasive particles may be at least about 1 wt %, such as at least about 5 wt %, at least about 10 wt % or at least about 15 wt % of the total weight of the particles. In another aspect, the coating may comprise not greater than 30 wt %, such as not greater than about 25 wt %, not greater than 20 wt %, or not greater than 18 wt % of the total weight of the abrasive particle. It will be appreciated that the total weight of coating of the abrasive particles may be in a range from any of the minimum and maximum values noted above, such as from about 1 wt % to about 30 wt %, from about 10 wt % to about 25 wt % or from about 15 wt % to about 2 wt %.

In a further embodiment, the D50_{b} value of the coated abrasive particles in a batch may be at least about 1 μm, such as at least about 2 μm, at least about 3 μm or at least about 4 μm. Furthermore, the D50_{b} value of the coated abrasive particles may be not greater than about 9 μm, such as not greater than about 8 μm, not greater than about 7 μm, not greater than about 6 μm or not greater than about 5 μm. It will be appreciated that the average particle size can be in a range from any of the minimum to maximum values noted above, such as from about 1 μm to about 9 μm, from about 2 μm to about 8 μm, or from about 3 μm to about 5 μm.

In one embodiment, ultrasonic energy may be applied continuously to the bath during the entire coating process. In another embodiment, the ultrasonic energy may be applied periodically during the coating procedure. For example, ultrasonic energy may be pulsed at discrete time intervals and at a discrete power.

In embodiments, the bath may further comprises at least one additive, such as a reducer, a catalyst, a stabilizer, a pH regulating agent, an electrolyte, and a combination thereof.

In another embodiment, the pH of the bath may be acidic, such as not larger than about 6.5, not larger than about 6.0, not larger than about 5.5, not larger than about 5.0, or not larger than about 4.5. Furthermore, the pH of the bath may be at least 2.0, such as at least 2.5, at least 3.0, or at least 3.5. It will be appreciated that the pH of the plating bath may be in a range from any of the minimum to maximum values noted above, such as from about 2.0 to 6.5, from about 2.5 to 6.0 or from about 3.0 to 5.0.

In yet another embodiment, the temperature of the bath may be adjusted to accommodate the type of metal to be coated on the abrasive particles. In one aspect, the bath temperature may be at least about 140° F., such as at least about 145° F. or at least about 150° F. In another aspect, the temperature of the plating bath may be not larger than about 200° F., such as not larger than 190° F., or not larger than 180° F. It will be appreciated that the temperature of the bath may be in a range from any of the minimum and maximum values noted above, such as from about 140° F. to about 200° F., from about 150° F. to about 190° F., or from about 160° F. to about 180° F.

In accordance with another aspect, the batch of coated abrasive particles according to the embodiments can be attached to a fixed abrasive article. For example, the method can include attaching a batch of coated abrasive particles to a substrate, wherein the batch of coated abrasive particles comprises a non-agglomeration factor (NAF) of at least about 0.9. In one embodiment, the substrate may be a wire, a disk, an annulus, a hone, or a cone.

The material of the substrate can include a metal or metal alloy. Some substrates can include a transition metal element as recognized in the Periodic Table of Elements. For example, the substrate may incorporate elements of iron, nickel, cobalt, copper, chromium, molybdenum, vanadium, tantalum, tungsten, and the like. In accordance with a particular embodiment, the substrate can include iron, and more particularly steel.

In a preferred embodiment, the method may include fixing of the coated abrasive particles, including for example, diamond particles having a metal coating (e.g., nickel) on a wire substrate to produce a fixed diamond wire (FDW). In a particular embodiment, the coated abrasive particles can be attached to the wire substrate by various deposition processes, including but not limited to plating, electrolytic plating, electroless plating, brazing, and a combination thereof. In a further embodiment, a bonding layer may be included overlying the attached nickel coated diamond particles thereby securing the diamond particles to the wire substrate.

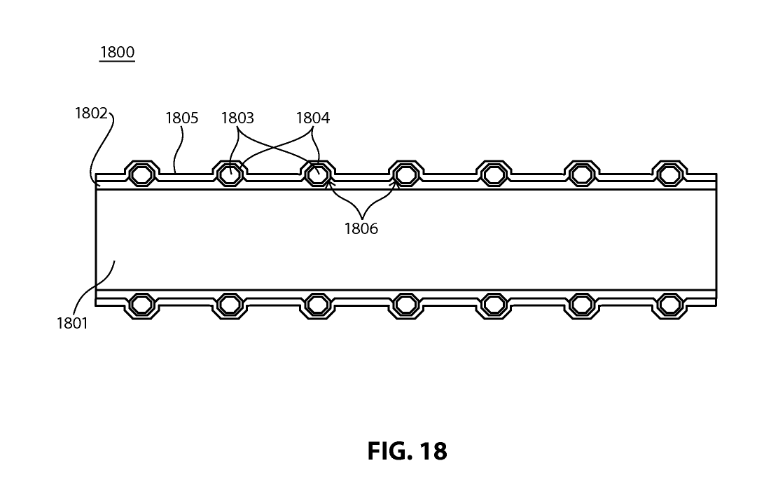

An illustration of a cross-sectional portion of a FDW according to one embodiment is shown in FIG. 18. The FDW 1800 illustrated in FIG. 18 includes a substrate 1801 in the form of an elongated member such as a wire. As further illustrated, the FDW can include a tacking film 1802 disposed over the entire external surface of the substrate 1801. Furthermore, the FDW can include abrasive particles 1803 including a coating layer 1804 overlying the abrasive particles 1803. The abrasive particles 1803 can be bonded to the tacking film 1802. In particular, the abrasive particles 1803 can be bonded to the tacking film 1802 at the interface 1806, wherein a bonding region can be formed.

Without wishing to be bound to a particular theory, it is noted from the embodiments herein that the formation of a batch of certain small abrasive particles having a particular non-agglomeration factor may be facilitated by control of one or more processing variables, including for example, the power of the applied ultrasonic energy, the bath volume, and the amount of abrasive particles. The batch of coated abrasive particles of the present specification with an average particle size of ≦10 μm can be characterized by having a high quality conformal coating which extends over the entire surface area of the abrasive particles. The coated abrasive particles according to the embodiments herein can facilitate manufacturing of improved abrasive articles, including but not limited to fixed diamond wires, which may be formed with the coated abrasive particles of the embodiments herein to have improved kerf loss and providing high quality products.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Items

Item 1. A method for forming a batch of coated abrasive particles comprising providing a dispersion of abrasive particles in a bath, wherein an average particle size of the abrasive particles is ≦10 μm; coating the abrasive particles in the bath with a coating material; applying ultrasonic energy to the bath and adjusting a power of the ultrasonic energy to form a batch of coated abrasive particles having a non-agglomeration factor (NAF) of at least about 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

Item 2. The method of item 1, wherein the abrasive particles comprise a material selected from the group consisting of diamond, cubic boron nitride, silicon carbide, boron carbide, alumina, silicon nitride, tungsten carbide, zirconia or a combination thereof.

Item 3. The method of item 2, wherein the abrasive particles are diamond particles.

Item 4. The method of items 1, 2, or 3, wherein the coating comprises a material selected from the group consisting of nickel, titanium, copper, zinc, chrome, bronze, and combinations thereof.

Item 5. The method of item 4, wherein the coating comprises nickel.

Item 6. The method of item 5, wherein the coating consists essentially of nickel.

Item 7. The method of items 1, 2, or 3, wherein the average particle size of the abrasive particles is at least about 1 μm, such as at least about 2 μm, at least about 3 μm or at least about 4 μm.

Item 8. The method of items 1, 2, or 3, wherein the average particle size of the abrasive particles is not greater than 9 μm, such as not greater than 8 μm, not greater than 7 μm or not greater than 6 μm.

Item 9. The method of items 1, 2, or 3, wherein the non-agglomeration factor (NAF) is at least 0.92, such as at least 0.94, at least 0.96, or at least 0.97.

Item 10. The method of items 1, 2, or 3, wherein a content of abrasive particles in the dispersion is from 1.5 wt % to 3 wt % based on total weight of the dispersion.

Item 11. The method of items 1, 2, or 3, wherein adjusting the power of the ultrasonic energy comprises a using a power of at least about 50 Watt, such as at least about 70 Watt, at least about 100 Watt, at least about 150 Watt, at least about 200 Watt, at least about 400 Watt, at least about 600 Watt, or at least about 800 Watt.

Item 12. The method of items 1, 2, or 3, wherein adjusting the power of the ultrasonic energy comprises using a power not greater than about 1000 Watt, such as not greater than about 900 Watt, not greater than about 800 Watt, not greater than about 600 Watt, not greater than about 450 Watt, or not greater than about 200 Watt.

Item 13. The method of items 1, 2, or 3, wherein the ultrasonic energy is applied while coating the abrasive particles.

Item 14. The method of items 1, 2, or 3, wherein the ultrasonic energy is applied continuously or periodically.

Item 15. The method of items 1, 2, or 3, wherein the coating process comprises electroless plating.

Item 16. The method of items 1, 2, or 3, wherein a thickness of the coating is from about 1 nm and about 500 nm

Item 17. The method of items 1, 2, or 3, wherein the coating comprises 1 wt % to 30 wt % of the total weight of the coated abrasive particles.

Item 18. The method of items 1, 2, or 3, wherein the bath further comprises at least one additive selected from the group consisting of a reducer, a catalyst, a stabilizer, a pH regulating agent, and an electrolyte.

Item 19. A method for forming a batch of nickel coated diamond particles comprising providing a dispersion of diamond particles in a bath, wherein an average particle size of the diamond particles is ≦10 μm; coating the diamond particles in the bath with a coating material comprising nickel; applying ultrasonic energy to the bath and adjusting the power of the ultrasonic energy to form a batch of nickel coated diamond particles having a non-agglomeration factor (NAF) of at least about 0.90, the non-agglomeration factor defined as a ratio (D50ₛₐ/D50_{b}), wherein D50_{b} represents the median particle size of the batch of nickel coated diamond particles and D50ₛₐ represents the median particle size of the diamond particles prior to coating.

Item 20. The method of item 19, wherein the average diamond particle size is at least about 1 μm, such as at least about 2 μm, at least about 3 μm or at least about 4 μm.

Item 21. The method of item 19, wherein the average diamond particle size is not greater than about 9 μm, such as not greater than about 8 μm, not greater than about 7 μm or not greater than about 6 μm.

Item 22. The method of item 19, wherein the non-agglomeration factor (NAF) is at least 0.92, such as at least 0.94, at least 0.96, or at least 0.97.

Item 23. The method of item 19, wherein a content of diamond particles in the dispersion is from 1.5 wt % to 3.0 wt % based on the total weight of the dispersion.

Item 24. The method of item 19, wherein the coating of the diamond particles is conducted by electroless plating.

Item 25. The method of item 19, wherein adjusting the power of the ultrasonic energy comprises using a power of at least about 50 Watt, such as at least about 70 Watt, at least about 100 Watt, at least about 150 Watt, at least about 200 Watt, at least about 400 Watt, at least about 600 Watt, or at least about 800 Watt.

Item 26. The method of item 19, wherein adjusting the power of the ultrasonic energy comprises using a power not greater than about 1000 Watt, such as not greater than about 900 Watt, not greater than about 800 Watt, not greater than about 600 Watt, not greater than about 450 Watt, or not greater than about 200 Watt.

Item 27. The method of item 19, wherein the ultrasonic energy is applied while coating the diamond particles.

Item 28. The method of item 19, wherein the ultrasonic energy is applied continuously or periodically.

Item 29. The method of item 19, wherein the coating process comprises electroless plating.

Item 30. The method of item 19, wherein a thickness of the coating is from about 1 nm and about 500 nm.

Item 31. The method of item 19, wherein the coating comprises 1 wt % to 30 wt % of the total weight of the coated diamond particles.

Item 32. The method of item 19, wherein the bath further comprises at least one additive selected from the group consisting of a reducer, a catalyst, a stabilizer, a pH regulating agent, and an electrolyte.

Item 33. A method of making an abrasive article comprising providing a substrate and attaching a batch of coated abrasive particles to the substrate, wherein the batch of abrasive particles comprises a non-agglomeration factor (NAF) of at least about 0.9, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

Item 34. The method of making an abrasive article according to item 33, wherein the substrate is selected from the group consisting of a disk, a wire, an annulus, a hone, a cone, and a combination thereof.

Item 35. The method of making an abrasive article according to item 33, wherein the abrasive particles are nickel coated diamond particles.

Item 36. The method of making an abrasive article according to item 35, wherein the nickel-coated diamond particles are attached to a wire substrate by electrolytic plating, thereby making a fixed diamond wire (FDW).

Item 37. The method of making a fixed diamond wire (FDW) according to item 36, further comprising including a bonding layer overlying the attached nickel coated diamond particles thereby securing the diamond particles to the wire substrate.

Item 38. A batch of coated abrasive particles having an average particle size≦10 μm and a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

Item 39. The batch of coated abrasive particles according to item 38, wherein a material of the abrasive particles is selected from the group consisting of diamond, cubic boron nitride silicon carbide, boron carbide, alumina, silicon nitride, tungsten carbide, zirconia or any combination thereof.

Item 40. The batch of coated abrasive particles according to item 39, wherein the abrasive particles are diamond particles.

Item 41. The batch of coated abrasive particles according to items 38, 39, or 40 wherein the coating of the abrasive particles comprises nickel, titanium, copper, zinc, chrome, bronze, or combinations thereof.

Item 42. The batch of coated abrasive particles according to item 41, wherein the coating comprises nickel.

Item 43. The batch of coated abrasive particles according to item 42, wherein the coating consists essentially of nickel.

Item 44. The batch of coated abrasive particles according to items 38, 39, or 40, wherein the average particle size of the abrasive particles is at least about 1 μm, such as at least about 2 μm, at least about 3 μm or at least about 4 μm.

Item 45. The batch of coated abrasive particles according to items 38, 39, or 40, wherein the average particle size of the abrasive particles is not greater than about 9 μm, such as not greater than about 8 μm, not greater than about 7 μm or not greater than about 6 μm.

Item 46. The batch of coated abrasive particles according to items 38, 39, or 40, wherein the non-agglomeration factor (NAF) is at least 0.92, such as at least 0.94, at least 0.96, or at least 0.97.

Item 47. The batch of coated abrasive particles according to items 38, 39, and 40, wherein at least 95% of the coated abrasive particles comprise a conformal coating which extends over an entire surface area of the abrasive particles.

Item 48. The batch of coated abrasive particles according to item 47, wherein at least 99% of the coated abrasive particles comprise a conformal coating which extends over an entire surface area of the abrasive particles.

Item 49. An abrasive article, comprising the batch of abrasive particles according to items 38, 39, or 40.

Item 50. The abrasive article of item 49, wherein the abrasive particles are attached to a substrate.

Item 51. The abrasive article of item 50, wherein the substrate is selected from the group consisting of a disk, a wire, an annulus, a hone and a cone.

Item 52. The abrasive article of item 51, wherein the abrasive article is a fixed abrasive wire.

Item 53. The fixed abrasive wire of item 52, further comprising a bonding layer overlying the attached abrasive particles thereby securing the abrasive particles to the wire substrate.

Item 54. A batch of nickel-coated diamond particles having an average particle size≦10 μm and a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

Item 55. The batch of nickel-coated diamond particles according to claim 54, wherein the non-agglomeration factor (NAF) is at least 0.92, such as at least 0.94, at least 0.96, or at least 0.97.

Item 56. The batch of nickel-coated diamond particles according to item 54, wherein the nickel content in the coating is at least 60wt % based on the total weight of the coating.

Item 57. The batch of nickel-coated diamond particles according to item 54, wherein the coating consists essentially of nickel.

Item 58. The batch of nickel-coated diamond particles according to item 54, wherein a thickness of the coating is from about 1 nm to about 500 nm.

Item 59. The batch of nickel-coated diamond particles according to item 54, wherein the coating comprises 1 wt % to 3 wt % of the total weight of the nickel-coated diamond particles.

Item 60. The batch of nickel-coated diamond particles according to item 54, wherein the average diamond particle size is not greater than about 9 μm, such as not greater than about 8 μm, not greater than about tm or not greater than about 6 μm.

Item 61. The batch of nickel-coated diamond particles according to item 54, wherein the average particle size of the nickel-coated diamond particles is at least about 1 μm, such as at least about 2 μm, at least about tm or at least about 4 μm.

Item 62. The batch of nickel-coated diamond particles according to item 54, wherein the average particle size of the nickel-coated diamond particles is not higher than 9 μm, such as not higher than 8 μm, not higher than 7 μm or not higher than 6 μm.

Item 63. The batch of coated abrasive particles according to item 54, wherein at least 95% of the coated abrasive particles comprise a conformal coating which extends over an entire surface area of the abrasive particles.

Item 64. The batch of coated abrasive particles according to item 63, wherein at least 99% of the coated abrasive particles comprise a conformal coating which extends over an entire surface area of the abrasive particles.

### EXAMPLES

### Electroless Nickel Plating of Diamond Particles

For all experiments, diamond particles having an average particle size of 4 μm to 6 μm were used. The diamond particles were added to an aqueous nickel plating bath containing nickel sulfate (15-20 g/l), sodium hypophosphite, a dispersant, and an acidic pH. Ultrasonic energy was applied to the plating bath already before the diamond particles were added and continuously provided until the nickel plating process was finished. A summary of the experiments is shown in Table 1.

### Calculation of Non-Agglomeration Factor (NAF)

The NAF was calculated according to the formula NAF=D50ₛₐ/D50_{b} (formula 1), wherein D50ₛₐ is the diamond particle size before electroless nickel plating and D50_{b} is the D50 particle size after electroless nickel plating. The D50ₛₐ value, i.e., the D50 diamond particle size before nickel plating, for all experiments, including the comparative examples, was 4.624 μm.

### Particle Size Measurement

The measurement of the particle size distribution (PSD) of representative samples of the uncoated and coated diamond particles was conducted by laser diffraction technology using a Microtrac-X100 analyzer.

Table 1 summarizes the examples representative to the present invention, i.e., Examples E1 to E6, and Comparative Examples C1 to C6.

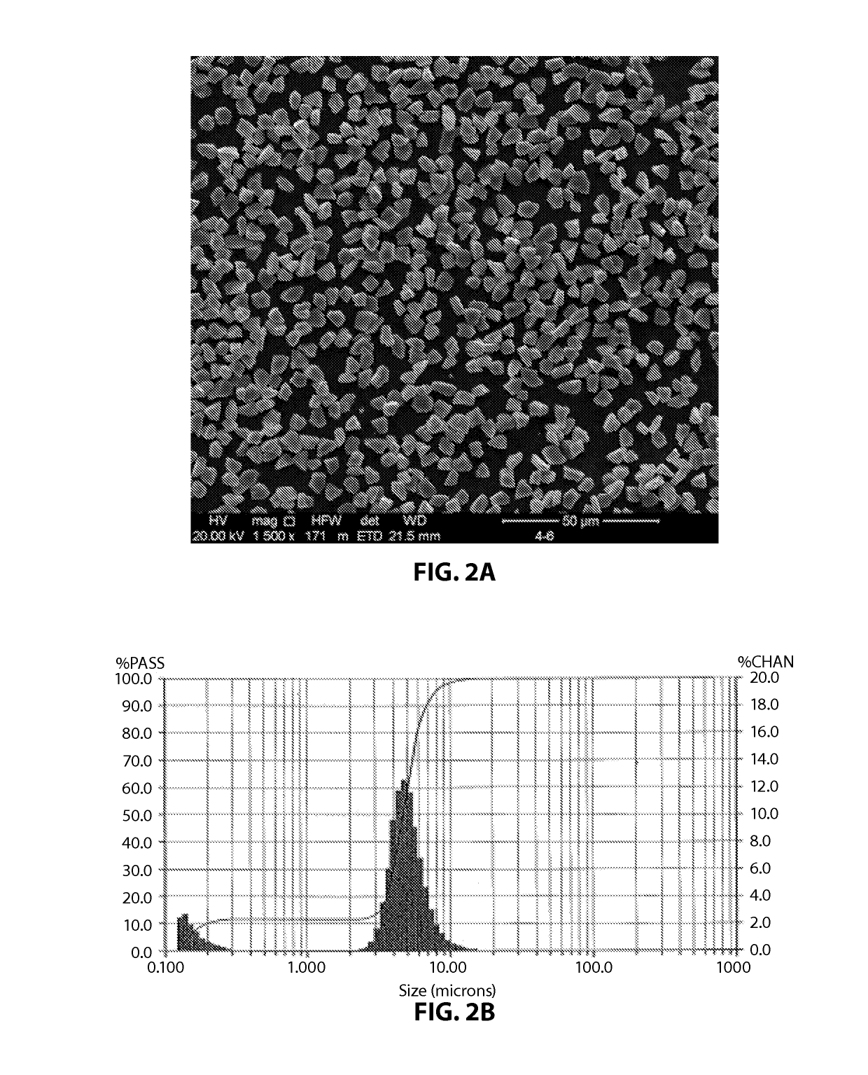

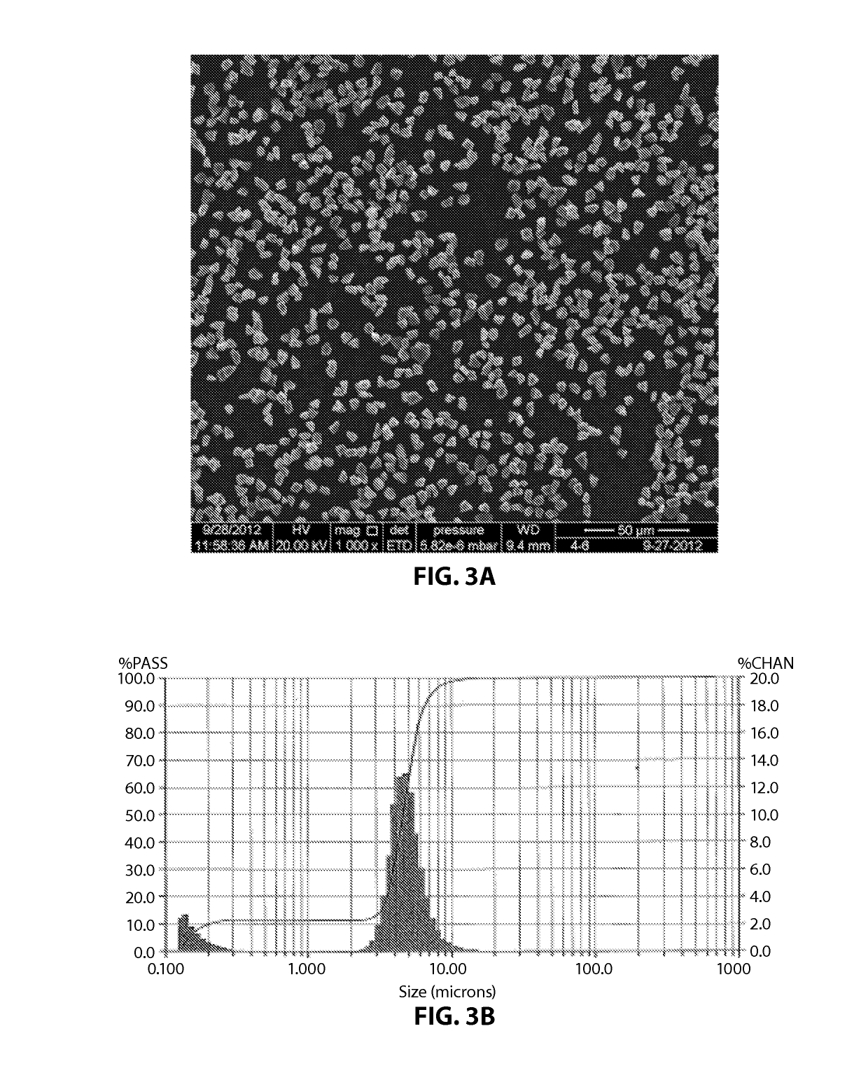

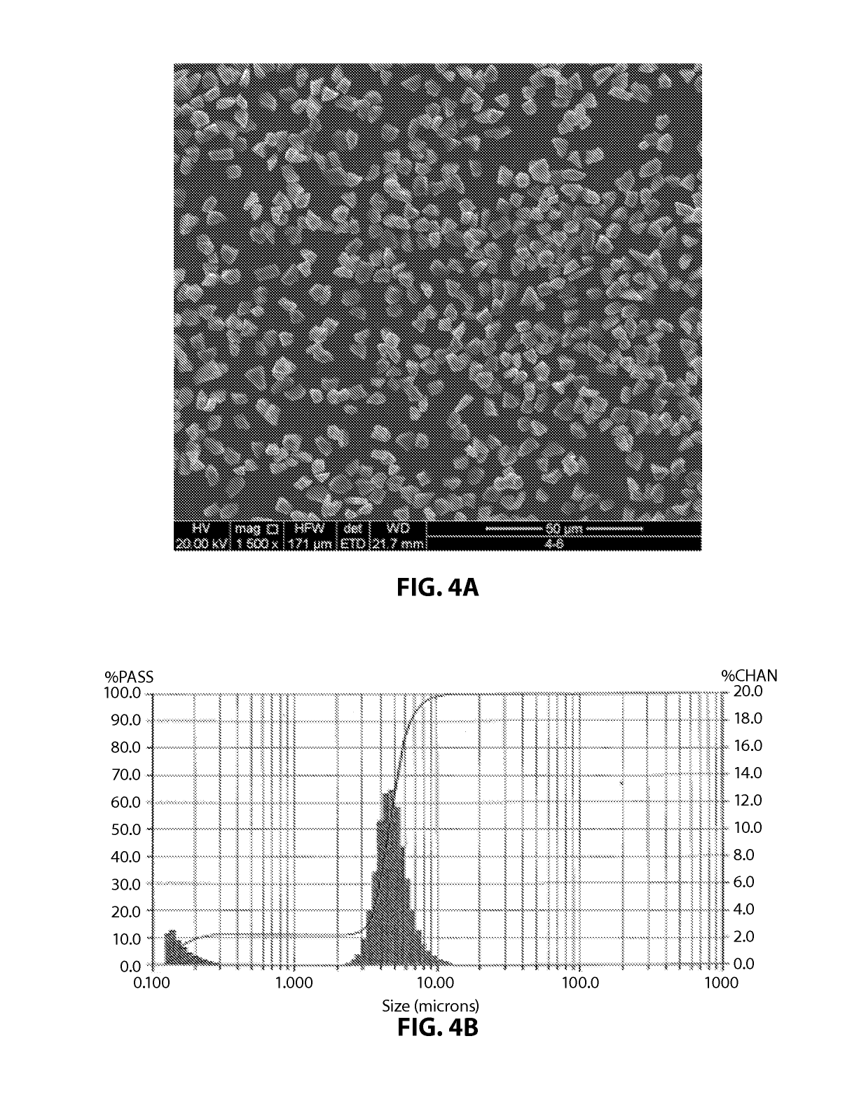

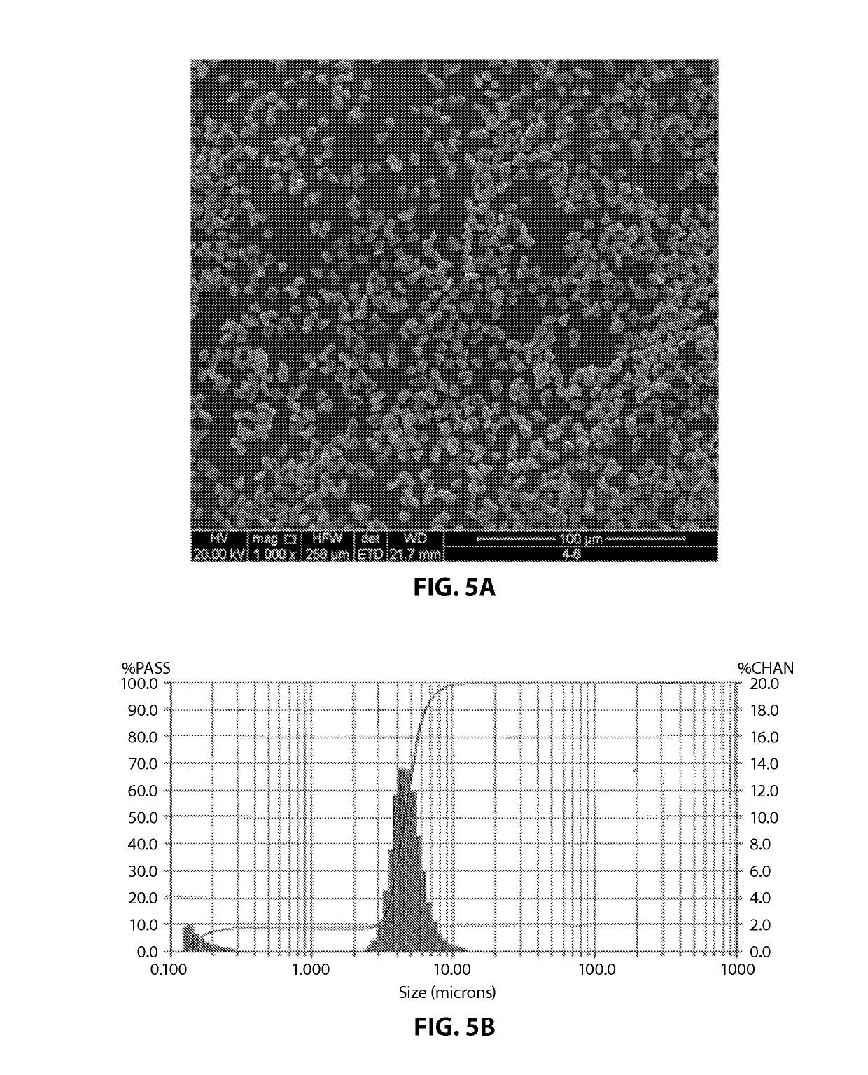

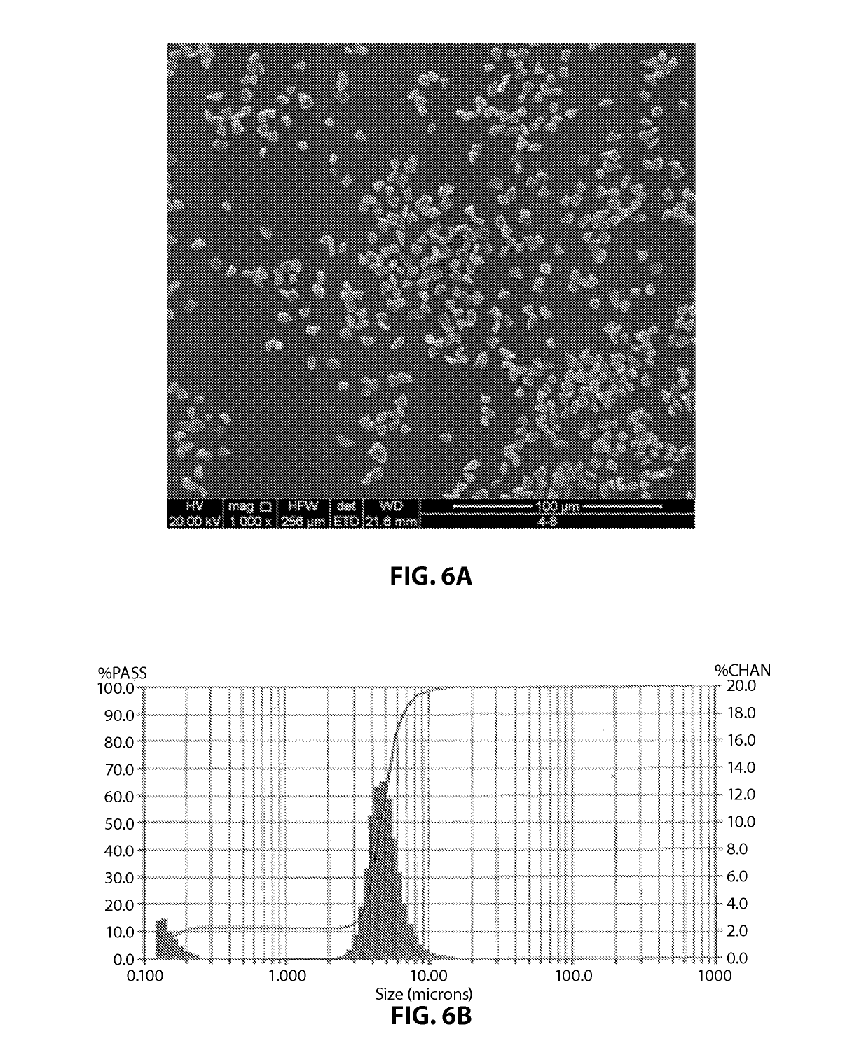

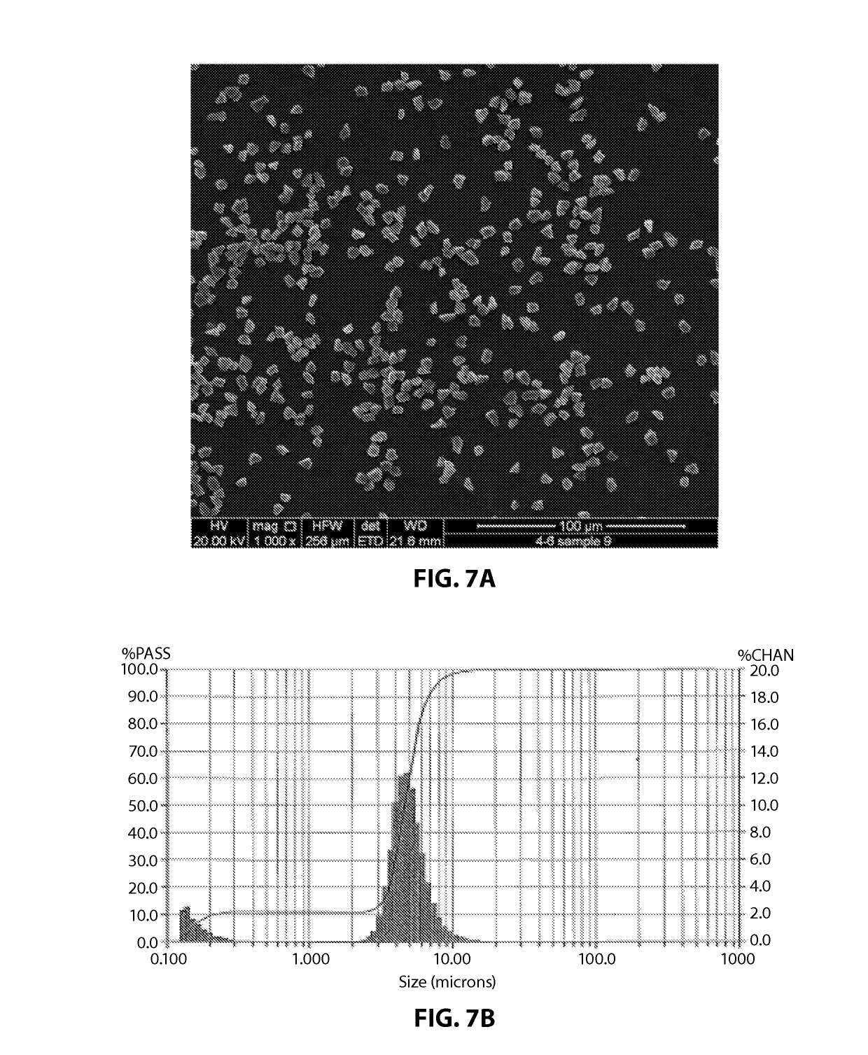

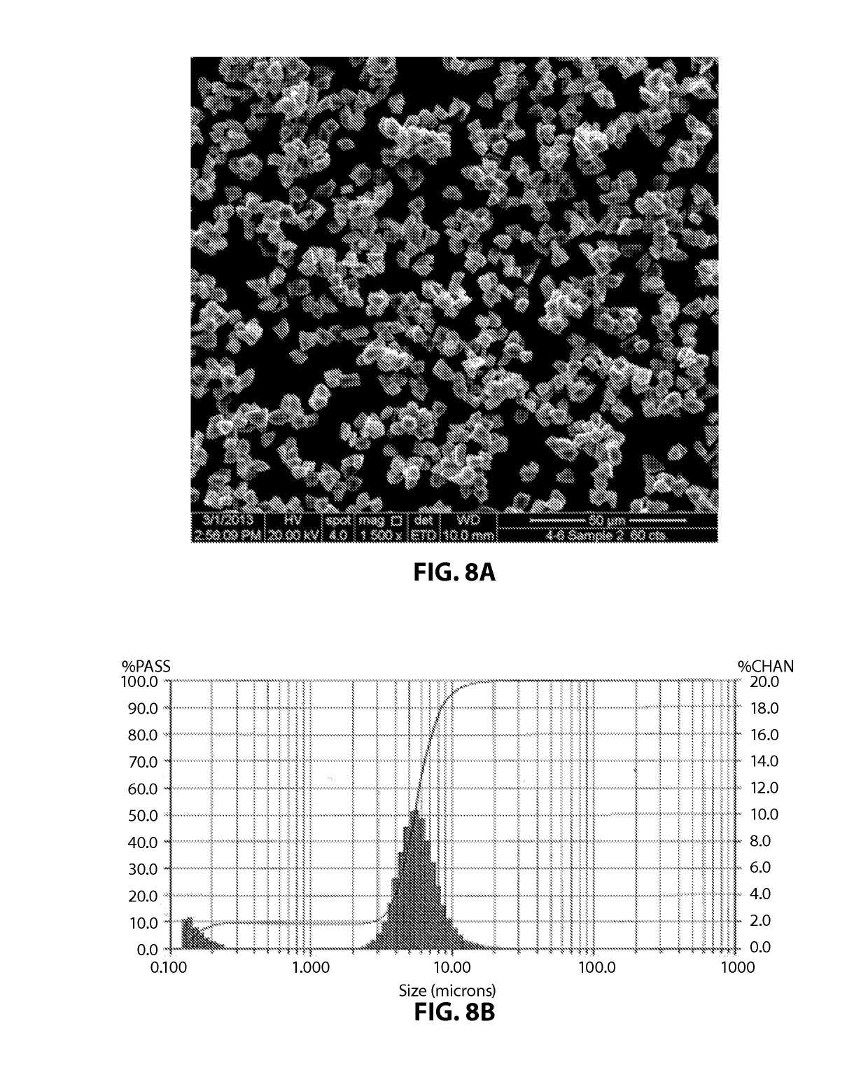

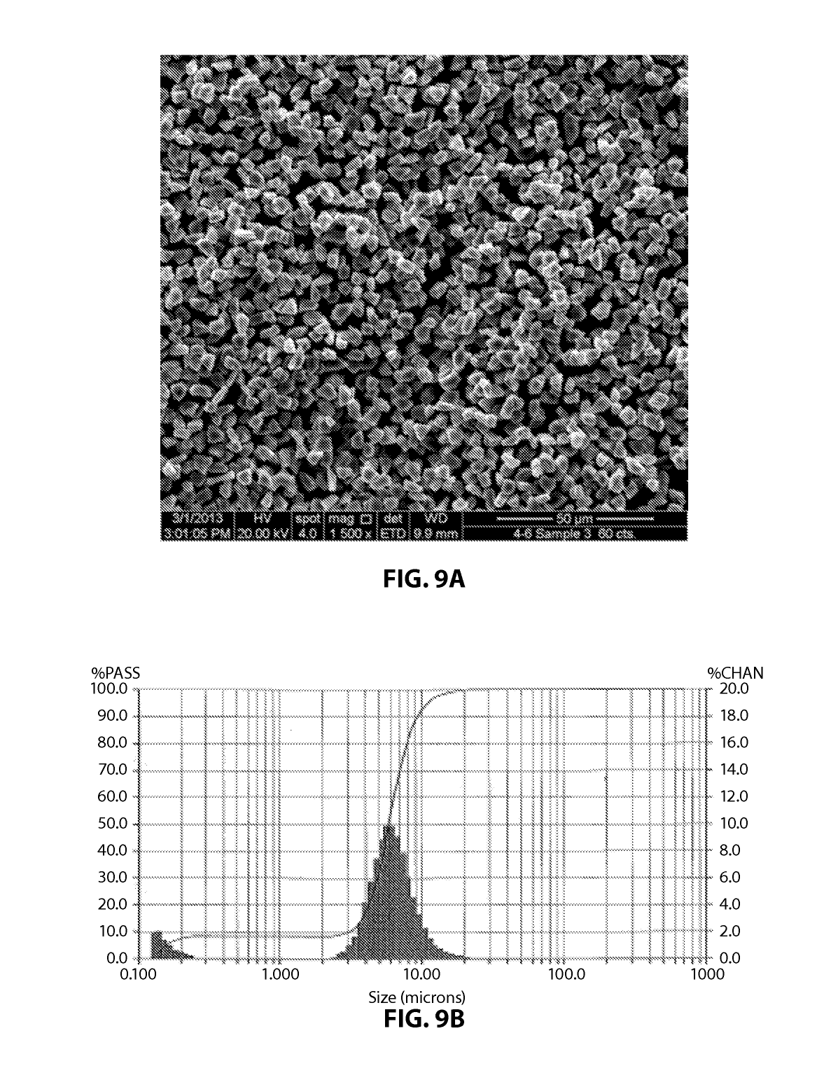

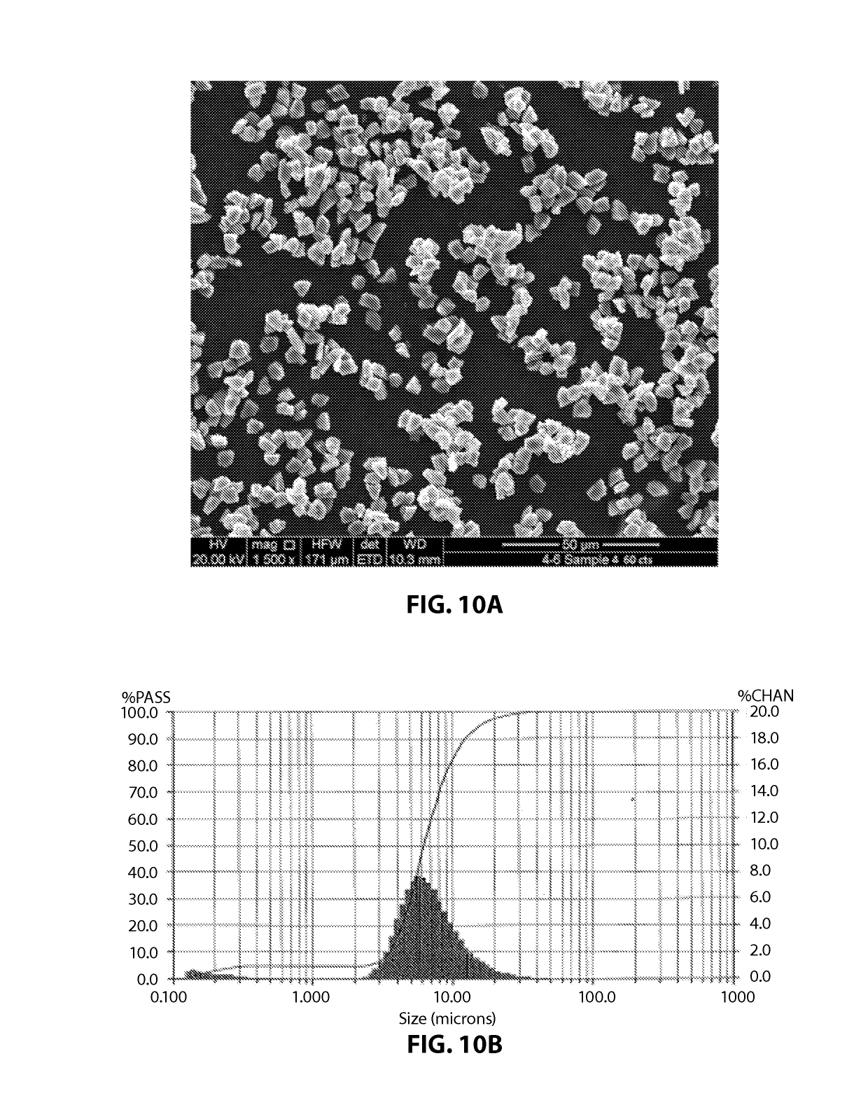

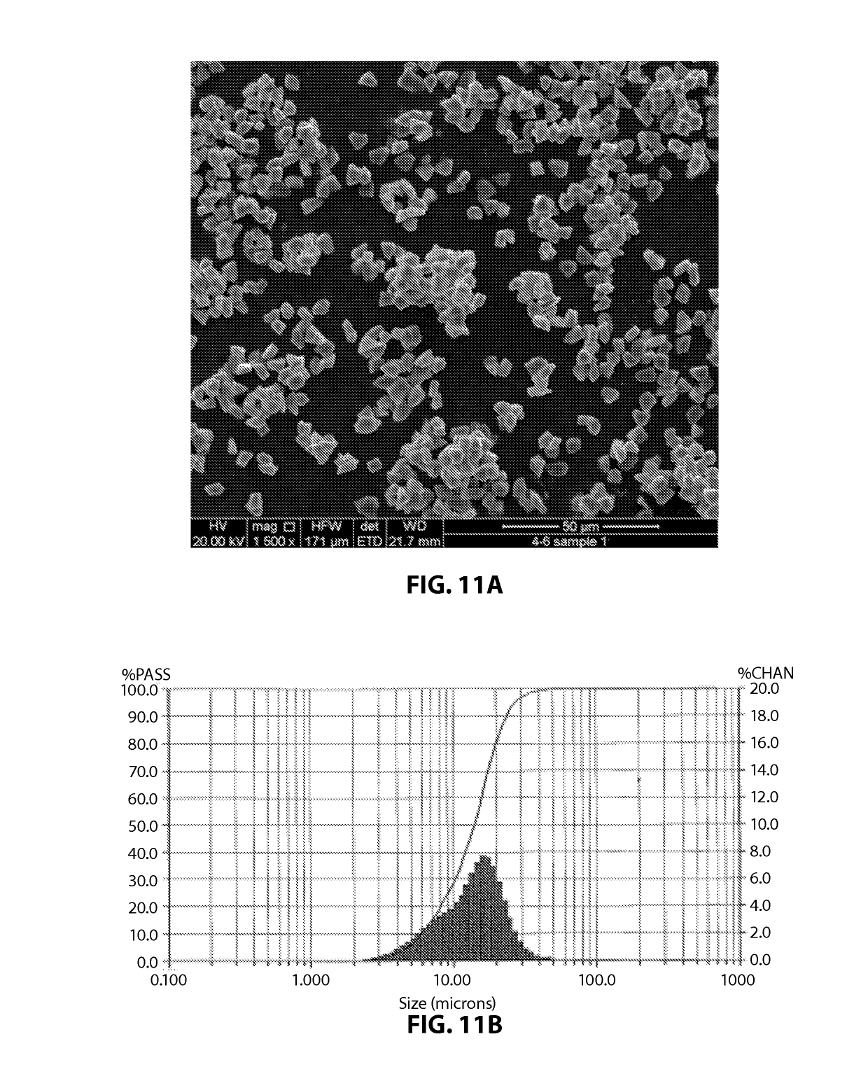

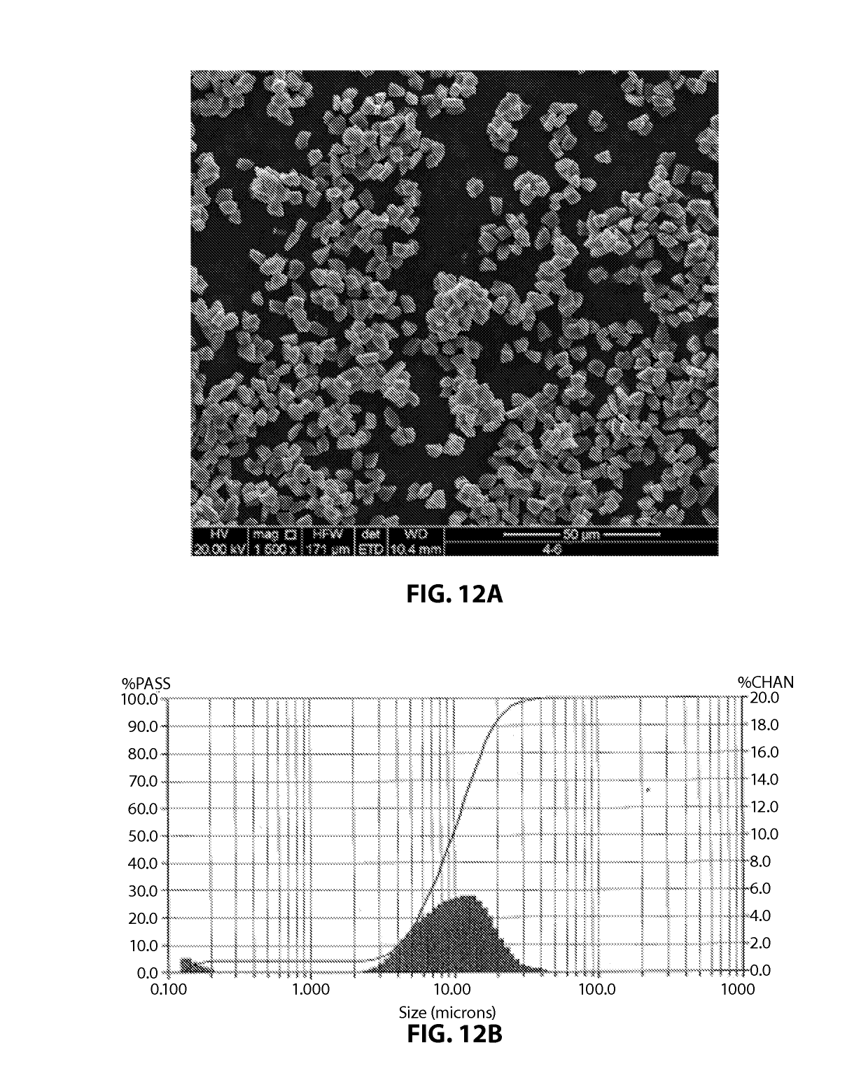

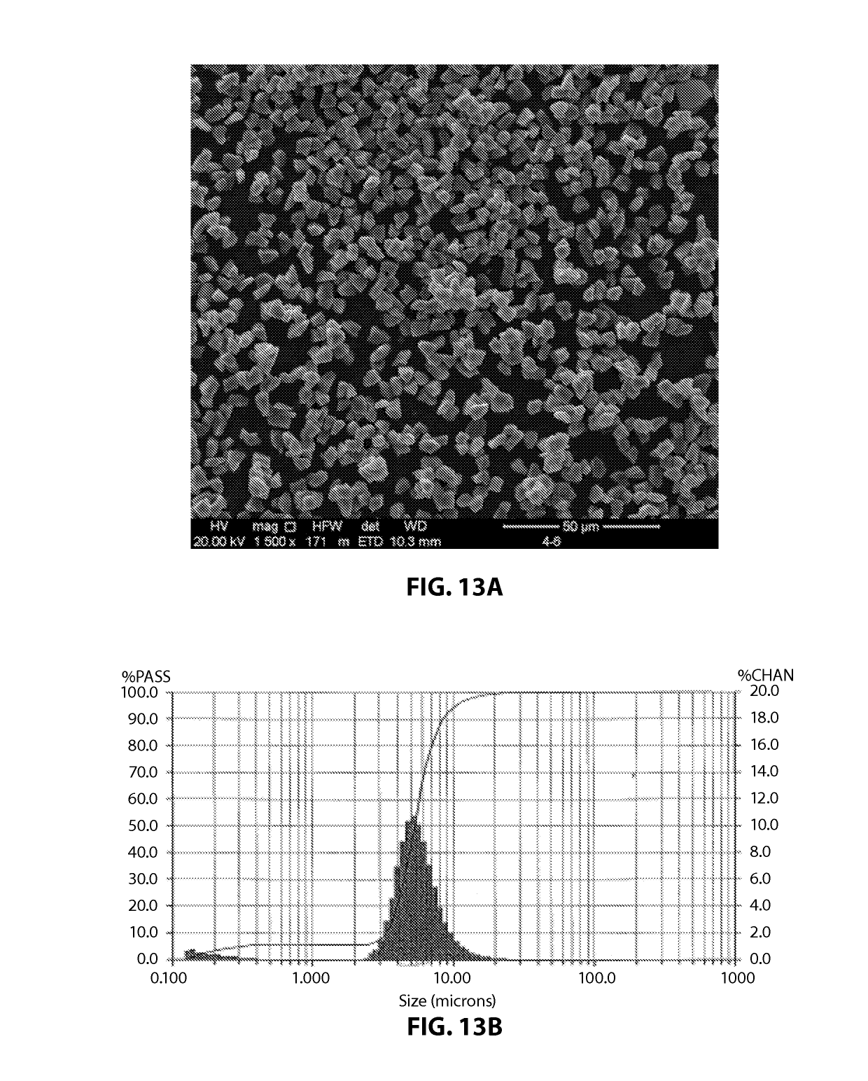

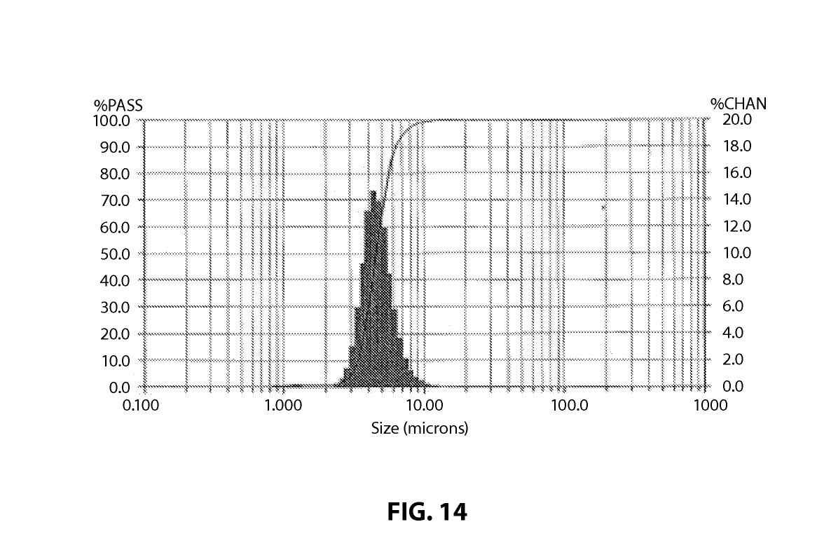

TABLE 1

| | | Sonic. | Bath | | Diamond | | | | | NAF |
|---|---|---|---|---|---|---|---|---|---|---|
| | SEM | Power | Volume | Volume/ | content | mv | D10 | D90 | D50_{b} | D50ₛₐ/ |
| Sample | image | [Watt] | [ml] | Power | [cts/ml] | [μm] | [μm] | [μm] | [μm] | D50_{b} |
| E1 | FIG. 2 | 70 | 68 | 0.97 | 0.147 | 4.669 | 0.198 | 6.979 | 4.753 | 0.973 |
| E2 | FIG. 3 | 125 | 370 | 2.72 | 0.135 | 4.537 | 0.203 | 6.660 | 4.637 | 0.997 |
| E3 | FIG. 4 | 180 | 444 | 2.47 | 0.135 | 4.539 | 0.216 | 6.667 | 4.654 | 0.993 |
| E4 | FIG. 5 | 290 | 600 | 2.07 | 0.133 | 4.586 | 0.273 | 6.531 | 4.628 | 0.999 |
| E5 | FIG. 6 | 345 | 717 | 2.08 | 0.139 | 4.581 | 0.184 | 6.732 | 4.676 | 0.989 |
| E6 | FIG. 7 | 400 | 870 | 2.175 | 0.138 | 4.643 | 0.222 | 6.892 | 4.692 | 0.985 |
| C1 | FIG. 8 | 150 | 444 | 2.96 | 0.135 | 5.626 | 2.767 | 8.619 | 5.516 | 0.838 |
| C2 | FIG. 9 | 120 | 444 | 3.7 | 0.135 | 6.089 | 3.139 | 9.400 | 5.925 | 0.780 |
| C3 | FIG. 10 | 90 | 444 | 4.93 | 0.135 | 7.422 | 3.594 | 12.68 | 6.346 | 0.728 |
| C4 | FIG. 11 | 70 | 254 | 3.63 | 0.118 | 14.85 | 6.078 | 23.88 | 14.25 | 0.324 |
| C5 | FIG. 12 | 70 | 135 | 1.93 | 0.148 | 10.94 | 4.164 | 19.31 | 9.825 | 0.471 |
| C6 | FIG. 13 | 70 | 108 | 1.54 | 0.139 | 5.739 | 3.396 | 8.639 | 5.341 | 0.866 |

It can be seen from Table 1 that for all representative Examples E1 to E6 the NAF is larger than 0.97. As indicated in Table 1, SEM images of particle samples of Examples E1 to E6 are shown FIGS. 2, 3, 4, 5, 6, and 7. As also shown in Table 1, the D50_{b} particle size after the nickel coating increases only minor, i.e., from 4.624 μm of the uncoated diamond particles size to a size from 4.628 μm to 4.753 μm in the coated state.

In contrast to Examples E1 to E6, Comparative Examples C1 to C6 demonstrate situations where the NAF is less than 0.9 and agglomeration of the batch of coated abrasive particles is recognized (see Table 1, for exact correspondence of figure number to sample number). As can be seen in the corresponding SEM images in FIGS. 8 to 13, the power of the ultrasonic energy was not sufficiently adjusted with respect to other process parameters, e.g., bath volume and solid load content, to prevent particle agglomeration and the formation of particle clusters.

As can be further seen in Table 1 with regard to the Comparative Examples, a much larger increase of the D50_{b} particle size after coating was measured, up to 14.25 μm, which indicates that the quality of the nickel coated diamond particles is inferior, i.e., having an uneven coating and the formation of undesirable larger particles.

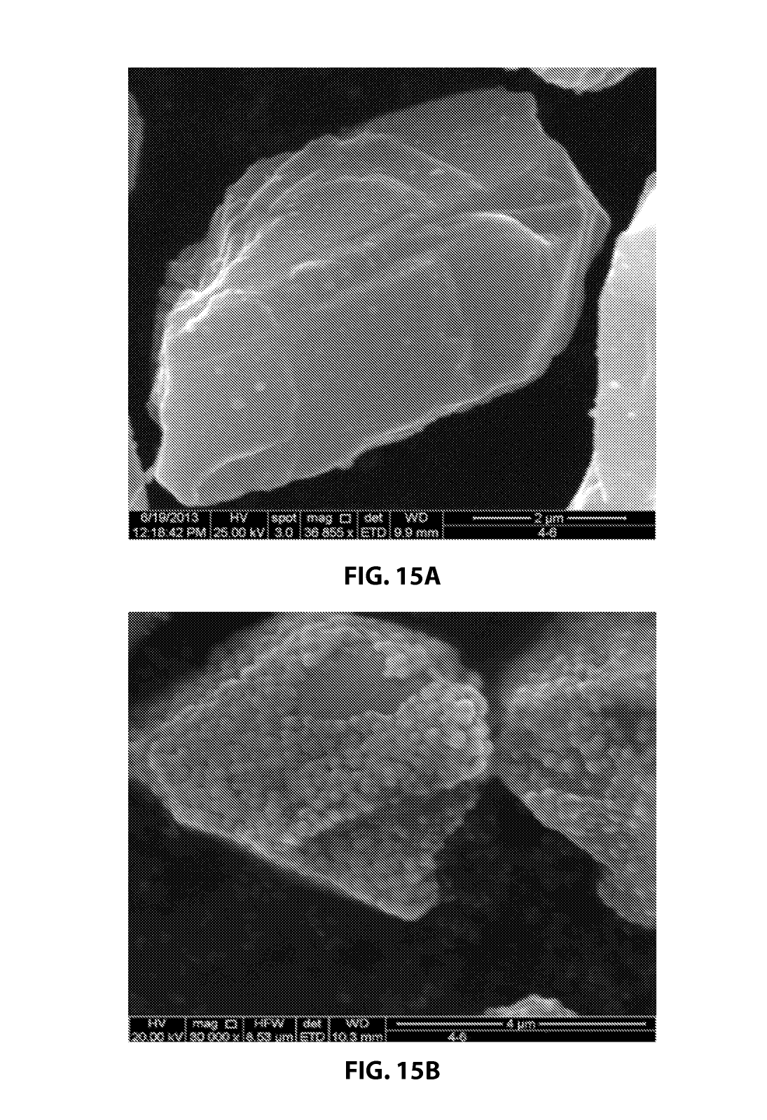

Upon further review of certain coated abrasive particles of the examples, it is also noted that the coated abrasive particles of the embodiments herein can have a particular coating quality relative to the coating quality of the comparative examples. For example, FIG. 15A shows a SEM image of certain nickel-coated abrasive particles from the batch of Example E6, having a NAF of 0.985. FIG. 15B shows an image of a nickel-coated abrasive particles of Comparative Example C5, having a NAF of 0.471.

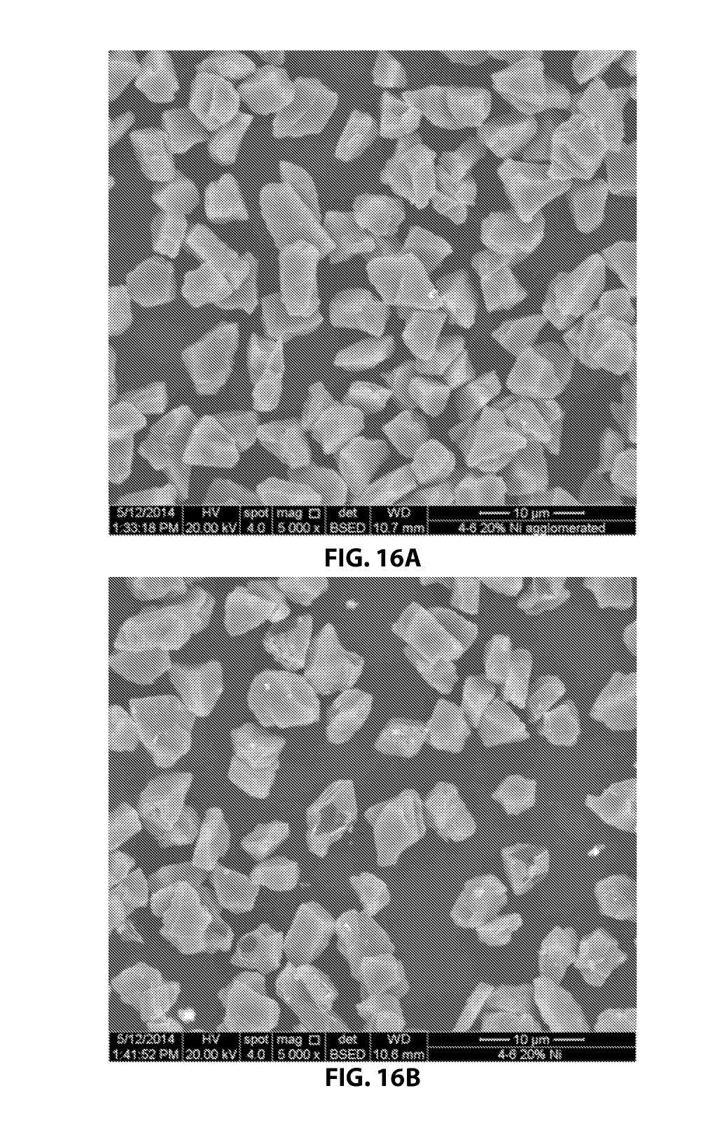

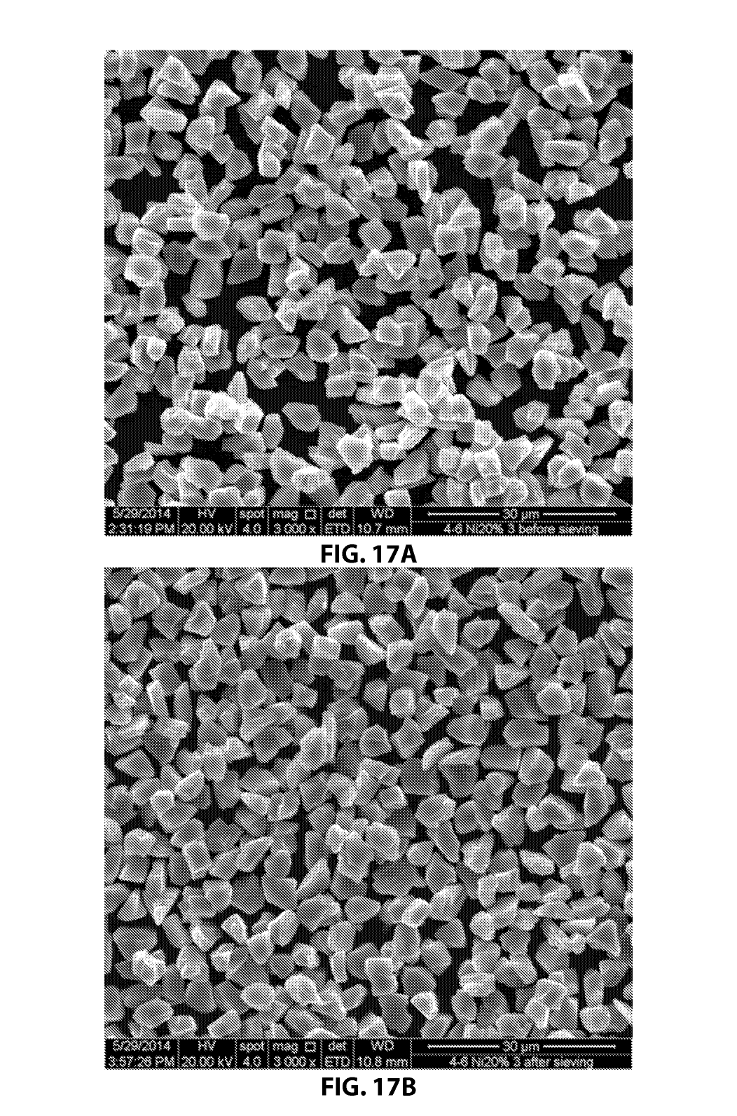

In certain instances, some conventional processes may attempt to use crushing and/or sieving techniques to control agglomeration, however, such processes are inefficient and appear to results in damage of the coating. As can be further seen from Comparative Example 7 (Table 2), crushing and sieving of agglomerated nickel-coated diamond particles through a 10 micron size sieve resulted in less agglomeration after the sieving (increase in NAF); however, the crushing and sieving caused observable damage of the nickel coatings of the abrasive particles (see FIGS. 16A and 16B). Moreover, even after crushing and sieving, the NAF of the nickel-coated particles of Comparative Example C7 did not increase to a NAF of at least 0.9 and is not comparable with the NAF of representative Examples E1-E6 of the present disclosure. In contrast, the nickel-coated diamond particles of Examples E1-E6 are easily to sieve and do not require crushing. Accordingly, in the case of conducting sieving through a 10 micron-size sieve of nickel-coated particles with a NAF of at least 0.9, the quality of the nickel coating can maintain unchanged after sieving (see FIGS. 17A and 17B).

TABLE 2
Comparative Example C7, 4-6 micron size diamond particles coated
with a 20 wt % nickel, subjected to crushing and sieving.

| | NAF (D50ₛₐ/D50_{b}) | D50_{b} |
|---|---|---|
| Before sieving | 0.710 | 6.513 |
| After sieving through a | 0.801 | 5.734 |
| 10 micron size sieve | | |

(D50_{b} = D50 of the coated diamond particles;
D50ₛₐ = D50 of the uncoated diamond particles = 4.624 μm.)

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A method for forming a batch of coated abrasive particles comprising
providing a dispersion of abrasive particles in a bath, wherein an average particle size of the abrasive particles is ≦10 μm;
coating the abrasive particles in the bath with a coating material;
applying ultrasonic energy to the bath and adjusting a power of the ultrasonic energy to form a batch of coated abrasive particles having a non-agglomeration factor (NAF) of at least about 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

2. The method of claim 1, wherein the abrasive particles comprise a material selected from the group consisting of diamond, cubic boron nitride, silicon carbide, boron carbide, alumina, silicon nitride, tungsten carbide, zirconia or a combination thereof.

3. The method of claim 2, wherein the abrasive particles are diamond particles.

4. The method of claim 1, wherein the coating comprises a material selected from the group consisting of nickel, titanium, copper, zinc, chrome, bronze, and combinations thereof.

5. The method of claim 1, wherein the coating comprises electroless nickel plating.

6. A method of making an abrasive article comprising providing a substrate and attaching a batch of coated abrasive particles to the substrate, wherein the batch of abrasive particles comprises a non-agglomeration factor (NAF) of at least about 0.9, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

7. The method of making an abrasive article according to claim 6, wherein the substrate is selected from the group consisting of a disk, a wire, an annulus, a hone, a cone, and a combination thereof.

8. The method of making an abrasive article according to claim 6, wherein the abrasive particles are nickel-coated diamond particles.

9. The method of claims 6, wherein the coating comprises electroless plating.

10. A batch of coated abrasive particles having an average particle size≦10 μm and a non-agglomeration factor (NAF) of at least 0.90, the non-agglomeration factor defined as a ratio (D50ₛₐ/D50_{b}), wherein D50_{b} represents the median particle size of the batch of coated abrasive particles and D50ₛₐ represents the median particle size of the abrasive particles prior to coating.

11. The batch of coated abrasive particles according to claim 10, wherein a material of the abrasive particles is selected from the group consisting of diamond, cubic boron nitride silicon carbide, boron carbide, alumina, silicon nitride, tungsten carbide, zirconia or any combination thereof.

12. The batch of coated abrasive particles according to claims 10, wherein the coating of the abrasive particles comprises nickel, titanium, copper, zinc, chrome, bronze, or combinations thereof.

13. The batch of coated abrasive particles according to claim 11, wherein the abrasive particles comprise diamond particles and the coating comprises nickel.

14. The batch of coated abrasive particles according to claim 13, wherein the coating consists essentially of nickel.

15. The batch of coated abrasive particles according to claim 10, wherein the average particle size of the abrasive particles is at least about 1 μm and not greater than 7 μm.

16. The batch of coated abrasive particles according to claim 10, wherein a thickness of the coating is from about 1 nm to about 500 nm.

17. The batch of coated abrasive particles according to claim 10, wherein at least 95% of the coated abrasive particles comprise a conformal coating which extends over an entire surface area of the abrasive particles.

18. The batch of coated abrasive particles according to claim 17, wherein at least 99% of the coated abrasive particles comprise a conformal coating which extends over an entire surface area of the abrasive particles.

19. An abrasive article, comprising the batch of abrasive particles according to claim 10.

20. The abrasive article according to claim 14, wherein the abrasive article is a fixed abrasive wire.
